(19) United States
(12) Patent Application Publication
(10) Pub. No.: US 2026/0242106 A1
(43) Pub. Date: Aug. 20, 2026

(54) A CAP AND BOTTLE ASSEMBLY FOR THE SIMULTANEOUS STORAGE OF TWO DIFFERENT FILLINGS, A METHOD OF MANUFACTURING SAID ASSEMBLY AND A METHOD OF ADJUSTING RATIO OF STORAGE VOLUMES OF THE ASSEMBLY

(71) Applicant: Jirí WOHLMANN, Ceske Budejovice (CZ)

(72) Inventor: Jirí WOHLMANN, Ceske Budejovice (CZ)

(21) Appl. No.: 19/160,574

(22) PCT Filed: Mar. 1, 2024
(86) PCT No.: PCT/CZ2024/050013

§ 371 Date: Aug. 28, 2025

(30) Foreign Application Priority Data
Mar. 3, 2023 (CZ) PV 2023-88

(51) Int. Cl. B65D 51/28; B29D 22/00; B29K 67/00; B65D 1/02; B65D 77/04

(52) U.S. Cl. CPC B65D 51/2885; B29D 22/003; B65D 1/0276; B65D 77/0493; B29K 2067/003

(57) ABSTRACT

The invention presents a cap (1) and bottle (2) assembly for the simultaneous storage of two different fillings, which allows the fillings to be mixed at the moment the cap (1) is removed. The assembly includes a straw (6), which acts primarily as a containment for the second of the stored fillings, and further as a drinking aid for the mixed fillings. The straw (6) is closed by bumping against a spike (5) of the bottle (2) facing the neck (3) of the bottle (2), which is part of the wall of the bottle (2), ideally the bottom of the bottle (2), and against a spike (4) of the cap (1), which is located under the upper base of the cap (1) and which faces into the bottle (2).

### FIELD OF THE INVENTION

The invention relates to a cap and bottle assembly having a standard structure from a conventional point of view, but in which the volume of the bottle is divided into two parts for simultaneous storage of two different fillings. The invention further relates to a method of manufacturing such a cap and bottle assembly, and the invention further relates to a method of adjusting the storage volume ratio of the assembly.

### BACKGROUND OF THE INVENTION

Bottles for the packaging and storage of liquids are characterised by a body defining a volume for containing the liquid and a neck for fitting a closure which accesses the volume of the bottle. The neck of the bottle is capped either by a disposable closure or by a thread for a screw cap. The cap and bottle assemblies are made from a variety of materials, but plastics are the most widely used.

Nowadays, plastic bottles are produced by the injection blow moulding method, so that during the production process, the preform of the bottle is inserted into a mould, after which the preform is shaped according to the mould by the action of heat and pressure. The cap of the plastic bottle is made by means of an injection mould and is fitted onto the bottle after it has been filled. This is a production method that is suitable for mass production.

On the other hand, this method of manufacture does not allow for the easy and rapid production of bottles with complicated structures, such as the multi-chamber bottle of the invention published in document PL 228 046 B1.

The multi-chambered bottle for storing bubble tea, introduced to the public, is essentially a jigsaw puzzle of several separately manufactured parts, where one part is screwed onto another, with the parts having recesses in their shells which form a space for storing a straw when the multi-chambered bottle is assembled. The assembled multi-compartment bottle is fixed with a tightening foil after the straw is packed. One volume is used to store the beverage, the other volume is used to store the gelatine beads.

The disadvantage of the aforementioned multi-chamber bottle lies in its complicated production, which involves a number of process steps that make it more expensive to produce. At the same time, disruption of the shrink wrap compromises the sterility of the straw and, if the shrink wrap is missing, it is not possible to avoid the bottle breaking down into its individual components by improper handling.

Another example is the technical design of the compound bottle presented in document CN 205 916 448 U, which at first sight looks like a standard plastic bottle but is composed of two halves. The compound bottle is split vertically from the neck to the base, the halves fitting together in a locked fashion and are fixed together by a pen, a groove and a label applied around the perimeter of the compound bottle. In the neck of the halves of the folded bottle there are holes for a straw to be inserted through.

The compound bottle provides the consumer with two distinct fillings within a single commercial item, without the compound bottle being out of the ordinary handling of a standard bottle. The problem that the compound bottle does not solve is that the straw has to be supplied externally, so that without the straw, drinking from the halves of the compound bottle is impractical, the straw has to be packed in its own packaging, and the compound bottle does not allow for easy mixing of the stored different fillings before the moment of consumption.

The object of the invention is to provide a cap and bottle assembly for simultaneously storing two different fillings, which will allow the consumer to easily and quickly mix the separate stored fillings prior to the moment of consumption, which will include a hygienically wrapped straw, and which will have a production cost competitive with known multi-chamber plastic bottles for mass market deployment.

A companion object of the invention is to create a method of manufacturing a cap and bottle assembly that is as close as possible to the manufacture of standard plastic bottles to keep production costs low.

A further object of the invention is to provide a method of adjusting the ratio of storage volumes of the assembly for easy adaptation of the inventive assembly to different types of fillings.

### SUMMARY OF THE INVENTION

The object is achieved by creating a cap and bottle assembly for simultaneous storage of two different fillings according to the invention below.

In the cap and bottle assembly for simultaneous storage of two different fillings, the bottle has a neck for fitting the cap.

The essence of the invention is that the cap is provided with a spike pointing into the bottle, at the same time that the inner wall of the bottle is provided with a spike pointing towards the neck, wherein there is a straw inside the bottle for storing a second filling, the ends of which are bumped in a compound assembly on the spike.

The term “spike” means a thin, pointed piece of rigid material (e.t. glass, plastic, wood, metal), in this invention piece of the bottle or the cap. Synonymous for the term spike is thorn or mandrel or spine.

The design of the assembly allows the volume of the straw to be used as a storage volume for additional refills, as the bumped spikes prevent mixing of refills inside the bottle. The consumer mixes the fillings by pulling the straw out of the spike just before consuming the filling, and pulling the straw out of the spike is not a difficult task for the consumer. Thus, it is advantageous that the inventive assembly can be operated by all categories of consumers who can remove the cap from the bottle.

At the same time, the straw is an inseparable part of the assembly until the cap is removed, so the consumer cannot lose or dirty the straw and can always drink the drink through the straw. Advantageously, the straw is hygienically wrapped until the cap is removed.

The invented assembly solves several problems simultaneously. First, it solves the problem of storing two fillings in a single bottle. Next, it solves the problem of straws either being attached to the bottles in different ways or being purchased separately.

In a preferred embodiment of the invention, the spike inside the bottle is formed by a depression in the bottom of the bottle. This is advantageous again in several ways. Firstly, the bottoms of the bottles themselves are shaped to ensure that the bottles stand well on a flat surface, so that the formation of the spike does not substantially complicate or make the production of the bottle more expensive. Secondly, the bottom of the bottle is always opposite the capped neck in cylindrical bottle shapes, so that the straw is well centred for the filler when filling. In addition, the hollow recess saves the amount of plastic used to make the bottle.

With respect to the bottle cap, there is a preferred embodiment of the invention in which the cap spike is formed by a hollow in the top base of the cap. Up to now, the top base of the cap has been used for printing commercial messages. Which would be possible with the inventive assembly, but at the cost of using more plastic to manufacture the closure because the full body of the spike is plastic. However, if a commercial message is not necessary on the top base of the cap, it is possible to make a depression on the cap, so that the spike formed by the depression will be hollow.

As a further preferred embodiment of the invention, wherein the size of the depth of the cap is greater than the size of the height of the neck of the bottle. If this condition is introduced, when the cap is removed, a portion of the straw always protrudes above the cap, making it very easy to manipulate the straw with the lips without the involvement of the hands. If this condition is not in place, the consumer must detach the straw from the stem of the breech after removing the cap and then insert the straw between the lips. In addition, there is a risk that inattention may cause the straw to become lodged in the bottle. Thus, the above is advantageously addressed by the greater depth of the closure exceeding the length of the neck.

The further object of the invention is solved by creating a method of manufacturing a cap and bottle assembly according to the invention below.

The method of manufacture relates to the inventive cap and bottle assembly. A known method of manufacture is used in which the cap is made by injection moulding molten plastic into a mould and the bottle is made by blowing from a pre-mould.

The essence of the invention consists in the fact that simultaneously when the molten plastic is injected into the mould, the stem of the cap is formed and that simultaneously when the bottle is blown, the stem of the bottle is formed. This is achieved by simply reshaping the mould, and it is thus possible to produce caps and bottles for the inventive assembly without further modification to the manufacturing process and supply chain.

This brings an enormous advantage in terms of production costs per assembly that the well-known multi-chamber bottles and compound bottles do not have.

Another part of the invention also provides a method of adjusting the ratio of storage volumes of the inventive cap and bottle assembly.

The essence of the inventive method of adjusting the ratio of storage volumes is that the storage volume of the straw is adjusted by the length of the portions of the spike inserted into the straw. Alternatively, or in combination with the previous option, the volume of the straw is varied by selecting the diameter of the straw. Alternatively, or in combination with at least one previous option, the straw storage volume is adjusted by selecting the length of the straw and the depth of the closure. Alternatively, or in combination with at least one previous option, the straw storage volume is adjusted by the shape of the straw.

Advantageously, by working with the straw it is possible to adjust the ratio of storage volumes of the inventive assembly without having to change the shape and dimensions of the bottle.

Advantages of the invention include the ability of the cap and bottle assembly to store two different fillings until the moment of consumption, the ease of mixing the two fillings prior to the moment of consumption, the presence of a straw that cannot be damaged, lost, or contaminated by normal bottle handling until the cap is removed from the bottle, and the protection of the straw filling from external influences by surrounding the bottle filling and/or the straw wall, e.g., from direct sunlight.

Further, the advantages of the invention include the ease of manufacture of the components of the inventive assembly, which gives the invention a high degree of competitiveness over other known split volume bottle inventions.

Furthermore, the advantages of the invention include a large variability of volume ratios for storing different fillings, which will allow the inventive assembly to be used in many areas of packaging two fillings simultaneously, particularly in the food industry.

### CLARIFICATION OF DRAWINGS

The present invention is explained in more detail in the following figures, where:

FIG. 1 shows the invented assembly without fillings,

FIG. 2 shows the inventive assembly with refills for drinking bubble tea,

FIG. 3 shows a bottle of the inventive assembly during insertion of a straw,

FIG. 4 shows the capping of the inventive assembly onto a bottle with a straw,

FIG. 5 shows the inventive assembly with a hinged cap.

### EXAMPLES OF THE INVENTION EMBODIMENTS

It is understood that the specific embodiments of the invention described and illustrated below are presented for purposes of illustration and not as a limitation of the invention to the examples provided. Those skilled in the art will find or be able to provide, using routine experimentation, a greater or lesser number of equivalents to the specific embodiments of the invention described herein.

The described example embodiment of the invention envisages the use of plastic as a material for the production of the invention, in particular because of the expected mass distribution of the inventive cap 1 and bottle 2 assembly. On the other hand, if it is not important to minimize the production costs, the inventive cap 1 and bottle 2 assembly can also be produced from other materials such as glass, metal, or a combination of all of the above materials.

A condition for the choice of the material is health safety if the invention is used in the food industry or in pharmacy, or chemical and physical stability if the invention is used for storage of e.g. two-component paints, adhesives, etc.

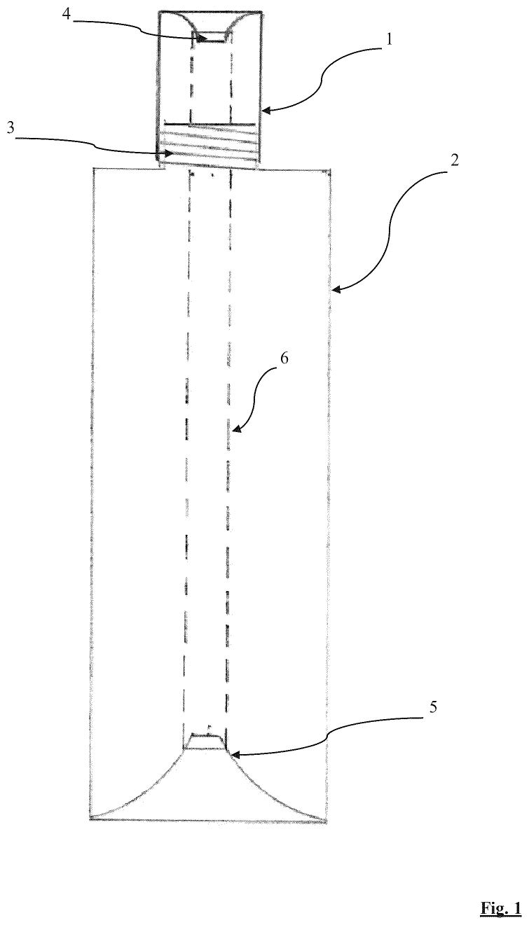

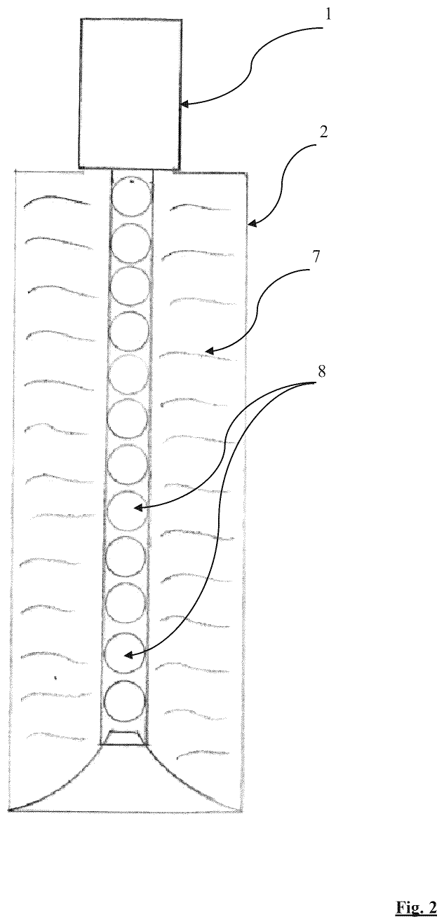

The following example embodiment of the invention, accompanied by FIG. 1 and FIG. 2, is directed to the packaging of foodstuffs, more particularly beverages intended to be consumed after mixing two fillings. The specific example embodiment of the invention is an assembly of a cap 1 and a bottle 2 for storing bubble tea. A bubble tea (more commonly retained in the marketplace by the untranslated name “bubble tea”) is a beverage that combines tea 7 with gelatine balls 8, wherein the gelatine balls 8 contain a filling that is intended to provide pleasure and experience to the consumer when combined with the tea 7. In order to maximize the experience of tasting the two flavours simultaneously, the gelatine balls 8 must be removed from the preservative brine and placed in the tea 7 just before consumption. If the gelatine balls 8 have been in the tea 7 for any length of time, osmotic effects will mix the fillings, resulting in one bland or unpalatable taste. Thus, it is clear that until the advent of the invention, the distribution of bubble tea outside of the kiosk was a costly and impractical affair that prevented the expansion of bubble tea into chain stores, vending machines, etc.

For the above reason, the use of the invented assembly is ideal. FIG. 1 shows a transparent illustration of an assembly of a cap 1 and a bottle 2, inside which a straw 6 is bumped on spikes 4 and 5 when the cap 1 is in place, thereby isolating the volume of the straw 6 from the volume of the bottle 2.

FIG. 2 shows the inventive assembly, which is filled with components for making bubble tea. The bottle 2 holds the tea 7, while the straw 6 holds the gelatine balls 8. The tea 7 has no access to the gelatine balls 8 because the straw 6 is closed by the spike 4 of the cap 1 and the spike 5 of the bottle 2. By removing the cap 1 and pulling the straw 6, the consumer pours the filling of the straw 6 into the filling of the bottle 2, whereupon the consumer can begin consuming the freshly prepared bubble tea with the full flavour of both fillings.

As mentioned above, the use on bubble tea is one possible use. The expert in two-component components will suggest other possible uses, not only for food but also for other fields of technology requiring separate storage of two fillings in one container until they are safely mixed and used. Where inedible fillings are involved, the straw 6 has only a storage function and does not serve as a means for consumption.

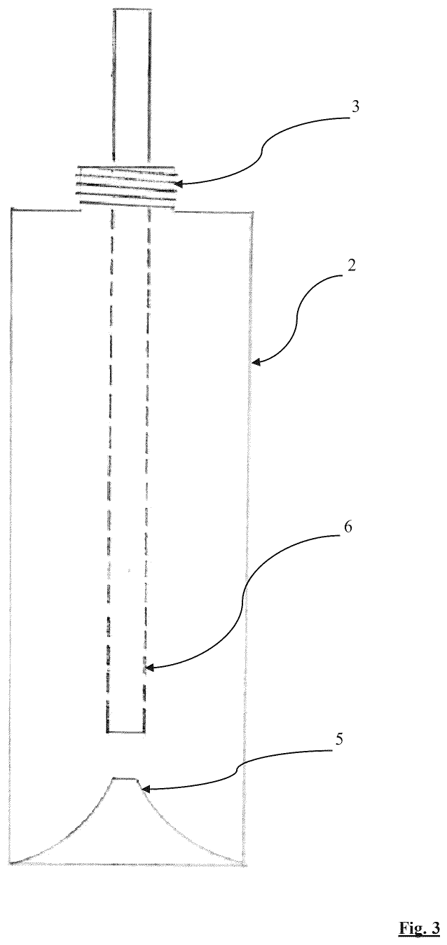

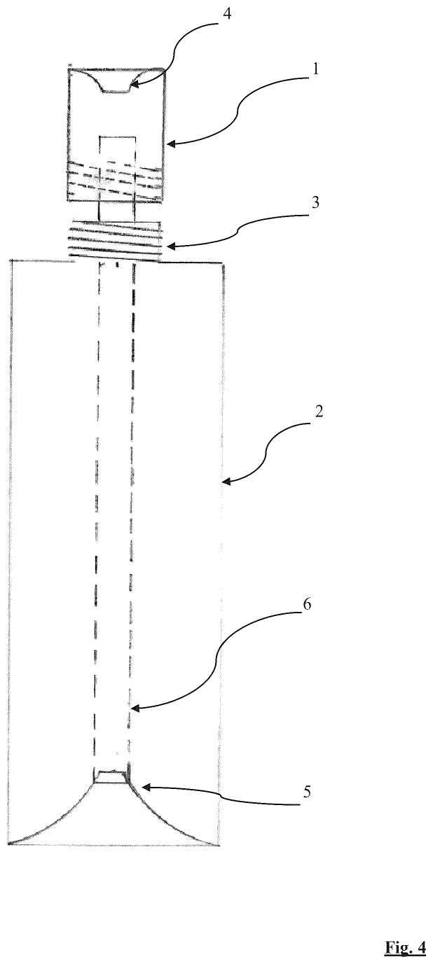

As for the assembly of the inventive assembly, first a bottle 2 is taken into which a straw 6 is inserted so that its end is bumped against the spike 5 of the bottle 2. The insertion of the straw 6 is shown in FIG. 3. The bottle 2 and the straw 6 are then filled, after which the cap 1 is fitted, the stem 4 of which closes the hitherto free end of the straw 6, see FIG. 4. The straw 6 is fixed and its volume is isolated from that of the bottle 2.

In the figures, the bottle 2 is depicted as cylindrical in shape, so that the spike 5 of the bottle 2 is located at the bottom of the bottle 2. The cylindrical variant of the bottle 2 shape is assumed to be the most common, given the current representation of cylindrical bottle packaging shapes in everyday life.

On the other hand, if the bottle 2 has, for example, an unrepresented shape of a crescent moon, a banana, a dolphin, the letter C, etc., or has a non-standardly positioned neck 3 such that it is not possible to draw a straight line between the bottom of the bottle 2 and the neck 3 of the bottle, the spike 5 of the bottle 2 can be formed anywhere on the inner wall of the bottle 2.

The volume of the bottle 2 may be selected by the expert as required, and is reduced by the volume of the straw 6. With respect to the volume of the straw 6, the volume of the straw 6 can be influenced in several ways. Either the storage volume of the straw 6 can be reduced by pushing the spikes 4 and 5 deeper into the straw 6, or the volume of the straw 6 can be influenced by changing the diameter of the straw 6, by changing the length of the straw 6, or by shaping the straw 6 to form expanded regions on the straw 6, e.g. resembling strung beads on a straight shank. The skilled person can choose from a wide variety of shapes and sizes of straws 6. With the change in diameter of the straw 6, it is also possible to change the diameter of the neck 3 of the bottle 2.

The straw 6 is made of plastic, as is the bottle 2 or the cap 1. Other materials for the production of the straw 6 are possible, but due to their cost it does not make economic sense to use them at the moment. On the other hand, the use of glass, metal or a combination of materials cannot be excluded by the skilled person.

With respect to the tested embodiment of the example of the invention, polyethylene phthalate (PET) was used for the straw 6 bottle 2 and the cap 1, which meets food standards and is sufficiently durable to perform the function of packaging.

At the time of filing the application of the invention, tests are underway with biodegradable plastics for food purposes from the group consisting of polylactic acid, polyglycolic acid, polyhydroxyalkanoate, biopolyethylene, biodegradable starch-based blends, regenerated cellulose and chitosan, and interim results show that a person skilled in the art can use biopolymers within the scope of the invention without having to worry that isolating the fillings from each other with a straw 6 would be ineffective.

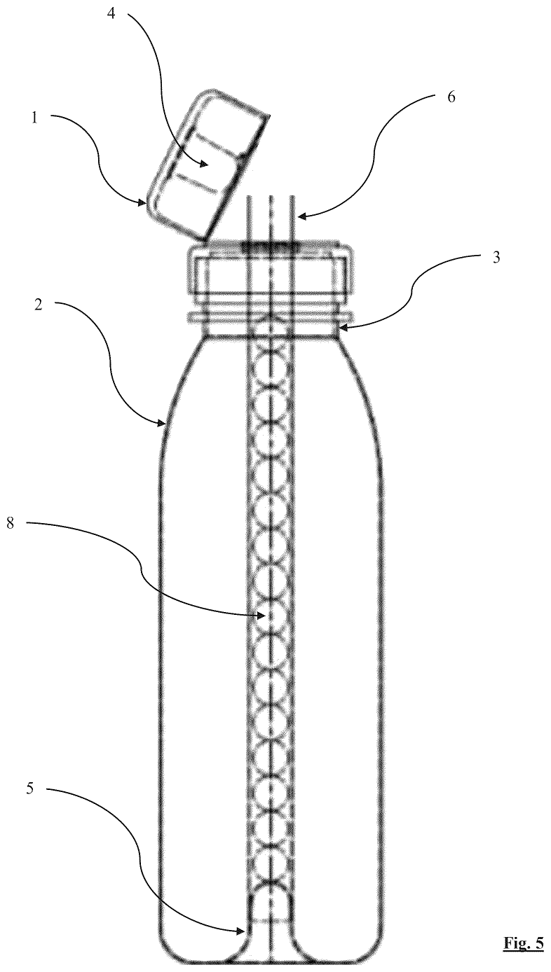

With respect to the cap 1, the skilled person may use screw caps 1 having an internal thread that engages with a thread formed on the outside of the neck 3 of the bottle 2. Alternatively, the cap 1 may be bumped on the neck 3 of the bottle 2 for a single tear. In a further alternative embodiment illustrated in FIG. 5, the cap 1 may be hinged for intermittent consumption of the bottle 2 filling.

The cap 1 is deep enough in the basic embodiment to accommodate the neck 3 of the bottle 2. On the other hand, it is more practical if the cap 1 is deeper than the length of the neck 3 of the bottle 2, so that the difference between the depth of the cap 1 and the length of the neck 3 corresponds to the length of the overhang of the straw 6 from the neck 3 of the bottle 2, see FIG. 1.

The cap 1 may either have a full spike 4, so that the cap 1 retains a flat upper base for the advertising message, or the spike 4 may be hollow, so that a depression is formed in the upper base of the cap 1, but with the advantage that less material is used to manufacture the cap 1.

The spike 5 of bottle 2 can also be full, with its base already formed on the preform, but this feasible solution is not popular because of the waste of material. A more preferred solution is one in which the spike 5 of the bottle 2 is hollow, and is formed by pushing a portion of the base of the bottle 2 towards the bottle 2 during the blowing of the preform, so that the spike 5 points with its tip towards the neck 3 of the bottle 2.

Since the vast majority of bottle containers are symmetrical, including their production moulds, the spike 5 of the bottle 2 is positioned in the middle of the bottom of the bottle 2 and thus points the tip directly into the neck 3 of the bottle 2.

Spikes 4 and 5 may have sharp points, rounded points, or may be shaped at the tip. However, they must always meet their basic characteristic of a pointed protrusion or projection whose expanding shape occludes the seated end of the straw 6.

The cap 1, the bottle 2 and the straw 6, as components of the inventive assembly, are manufacturable in existing production lines with minimal modification of the moulds. While nothing is changed for the production of the straw 6, for the production of the cap 1 it is sufficient to form a pointed formation in the injection mould which will produce a spike 4 on the cap 1 during the moulding process. Similarly, it is possible to modify the mould for blowing the bottles 2 out of the preforms. The pointed formations may be permanently in the moulds or may be removable. Otherwise, the production lines need not be significantly further interfered with.

### Industrial Applicability

A cap and bottle assembly for simultaneous storage of two different fillings, a method of manufacturing the inventive assembly, and a method of adjusting the ratio of storage volumes of the inventive assembly according to the invention will find application in packaging and storage, particularly in the food industry.

### OVERVIEW OF RELATIONSHIP TAGS

1 cap
2 bottle
3 neck
4 spike of the cap
5 spike of the bottle
6 straw
7 tea
8 gelatine ball

1. A cap (1) and bottle (2) assembly for the simultaneous storage of two different fillings, wherein the bottle (2) has a neck (3) for inserting the cap (1), characterized in that the cap (1) is provided with a spike (4) pointing into the bottle (2), that the inner wall of the bottle (2) is provided with a spike (5) pointing towards the neck (3), and that inside the bottle (2) there is a straw (6) for holding a second filling, the ends of which are bumped against the spikes (4, 5) in a folded assembly.

2. The cap (1) and bottle (2) assembly according to claim 1, characterized in that the spike (5) inside the bottle (2) is formed by the hollow in the bottom of the bottle (2).

3. The cap (1) and bottle (2) assembly according to claim characterized in that the spike (4) of the cap (1) is formed by the hollow of the upper base of the cap (1).

4. The cap (1) and bottle (2) assembly according to claim 1, characterized in that the size of the depth of the cap (1) is greater than the size of the height of the neck (3) of the bottle (2).

5. A method of manufacturing the cap (1) and bottle (2) assembly according to claim 1, wherein the cap (1) is manufactured by injection moulding molten plastic into a mould and the bottle (2) is manufactured by blowing from a pre-mould, characterized in that while injecting the molten plastic into the mould, the spike (4) of the cap (1) is simultaneously formed and, while blowing the bottle (2) out of the preform, the spike (5) of the bottle (2) is simultaneously blown.

6. A method of adjusting the ratio of the storage volumes of the cap (1) and bottle (2) assembly formed according to claim 1, characterized in that by sizing the storage volume of the straw (6) by at least one of the group consisting of adjusting the length of the spikes (4, 5) portions inserted into the straw (6), adjusting the diameter of the straw (6), adjusting the length of the straw (6) and adjusting the depth of the cap (1), adjusting the shape of the straw (6).
